(19) United States
(12) Patent Application Publication
(10) Pub. No.: US 2017/0196296 A1
(43) Pub. Date: Jul. 13, 2017

(54) Amphoteric Metal Compound-Treated Substrate And Methods For Reduction Of Body Odor Using Treated Substrates

(71) Applicant: William B. Lee, Salt Lake City, UT (US)

(72) Inventor: William B. Lee, Salt Lake City, UT (US)

(21) Appl. No.: 15/403,929

(22) Filed: Jan. 11, 2017

Related U.S. Application Data
(60) Provisional application No. 62/277,374, filed on Jan. 11, 2016.

(51) Int. Cl. A43B 1/00; A43B 17/10; A43B 17/00; A01N 59/20

(52) U.S. Cl. CPC A43B 1/0045; A01N 59/20; A43B 17/10; A43B 17/006

(57) ABSTRACT

Reduction of body odors arising from microbial activity in moist areas of the human body, particularly the foot area, is achieved by providing a substrate that is treated with an amphoteric metal compound solution, especially those containing copper, which provides a stable material that can be placed in proximity to a part of the body that typically develops body odor, the treated material providing extended efficacy in the prevention of odor caused by microorganisms despite continuous and repeated exposure of the treated substrate to sweat or laundering.

### CROSS-REFERENCE TO RELATED APPLICATION

This is a non-provisional application which claims priority to U.S. provisional application Ser. No. 62/277,374, filed Jan. 11, 2016, the contents of which are incorporated herein in their entirety.

### TECHNICAL FIELD

This disclosure relates in general to means and devices for the reduction of body odor in animals and, in particular, to the preparation and use of substrates that are treated with an amphoteric metal compound (AMH), particularly from the group of amphoteric metal hydroxides (AMH), which contain at least one hydroxy (OH) per molecule, as a means for reducing body odor.

### BACKGROUND OF THE DISCLOSURE

It is well-known that the presence of various microorganisms in moist environments of the human body leads to the production of odors that are generally perceived to be offensive. Such areas of the human body that provide moist environments include the axial region of the arms and the feet. Many remedies have been developed to ameliorate or eliminate such body odors, including deodorants and deodorizing devices.

Many remedies, especially those for reducing or eliminating foot odor, rely on the presence of carbon. Popular products that are available for foot odor control include Odor-Eater® brand insoles and Dr Scholl's brand Odor-X® insoles. These products are provided as inserts for placement in shoes and contain latex foam impregnated with activated carbon. The carbon has a very large surface area per gram and can absorb, and permanently bind with, various organics, such as isovaleric acid, a common component of foot odor. U.S. Pat. No. 3,842,519 to Lapidus discloses an early form of this type of product. The carbon-latex foam, when used alone, was found to shed carbon onto the foot, leaving an undesirable black stain. To correct this problem, a separator sheet was added. However, the separator sheet originally contained no odor-control properties, which lead to the ultimate production of odor on the separator sheet. It was later that the addition of bicarbonate of soda to the separator sheet resulted in satisfactory short-term performance with the adequate control of odor when used. A similar disclosure of such products is found in WO 1996/013994 and U.S. Pat. No. 5,197,208, both to Lapidus.

Carbon-based odor-reducing products, such as Odor-Eaters® and Odor-X® insoles do not have a long effective lifetime. Once the activated carbon becomes saturated with odors, it cannot absorb any more odor, even if washed. Further, the bicarbonate of soda on the separator sheet is water-soluble. Therefore, prolonged exposure to sweat, accidental immersion in water or washing of the insole can remove the bicarbonate of soda. As a result, the effective lifetime of these insoles is typically 4-8 weeks of continuous use.

Copper and copper-containing compounds are known to have certain effects on microorganisms, which may include the control or production of odor arising from bacteria. For example, U.S. Application No. 2010/0209460 to Pietsch generally discloses the use of an anti-odor agent having disinfecting or bactericidal effect, and identifies as one its uses the production of insoles for shoes. The application does not disclose the express nature of the copper or copper compounds that may be useful in producing such insoles.

The objects of the present invention are to provide a remedy that significantly reduces body odor by killing and/or inhibiting microorganisms that produce such odor, rather than simply absorbing the body odors into a substrate, and doing so with a substance that is effectively inert to the human body and not quickly diminished or rendered ineffective as a result of the anti-microbial activity or repeated exposure to water, such as through sweat or laundering. Further, it is desired to provide a simple-to-use remedy for body odor, particularly foot odor, either as an insole or a coating on the inside of shoes, which also has a very long lifetime, as compared to the 4-8 week useful life of current products. It is also an object to provide an odor-controlling product which is washable so that if the insole or treated material is soiled or stained, it can be cleaned without reducing its efficacy.

### SUMMARY

In a first aspect of the disclosure, embodiments are disclosed of methods for treating a substrate to control body odor, comprising providing a quantum of substrate material to be treated, providing an aqueous solution of an amphoteric metal hydroxide, providing an amount of ammonia for reaction with the amphoteric metal hydroxide, contacting the quantum of substrate material with the aqueous solution of an amphoteric metal hydroxide for a time sufficient to adhere the amphoteric metal hydroxide to the substrate material, drying the substrate material after contacting with the amphoteric metal hydroxide and ammonia, and shaping the substrate material to a size and dimension that is structured for placement in proximity to a wearer's body where body odor is produced.

In some embodiments, the methods further comprise the addition of a surfactant in admixture with the aqueous solution of an amphoteric metal hydroxide.

In certain embodiments, the ammonia is provided in the form of Schweizer's reagent solution.

In other embodiments, the amphoteric metal hydroxide is produced by the reaction of a metal salt with ammonia vapor while an aqueous solution of a metal salt is in contact with the substrate material.

In still other embodiments, the methods further comprise providing a polymer-based binder agent, and contacting said substrate with said binder agent.

In certain embodiments, the binder agent is contacted with the substrate material before contacting the substrate material with the aqueous amphoteric metal hydroxide.

In some embodiments, the methods comprise contacting the substrate material with a solution of sodium hydroxide, surfactant and additional amphoteric metal hydroxide after contacting said substrate with said aqueous amphoteric metal hydroxide.

In certain embodiments, the binder agent a liquid latex rubber.

In still other embodiments, the aqueous amphoteric metal hydroxide is produced from reaction of a water-soluble copper salt being admixed with a metal carbonate in aqueous solution, and the binder agent is a polyvinyl acetate emulsion glue, and further comprising the admixture of said aqueous amphoteric metal hydroxide and binder agent to water and Na₂CO₃ before contacting with said substrate.

In some embodiments, the aqueous amphoteric metal hydroxide contains Cu(OH)₂ and Al(OH)₃, and further, the aqueous amphoteric metal hydroxide is mixed with H₃PO₄ and is filtered, the filtrate then being admixed with a binder agent before being contacted with the substrate.

In yet other embodiments, the amphoteric metal hydroxide contains cupric hydroxide, copper carbonate hydroxide or hydrous basic copper aluminum phosphate (turquoise), or mixtures thereof.

In still other embodiments, the shaping of said substrate is performed before contacting said substrate with said aqueous amphoteric metal hydroxide.

In a second aspect of the disclosure, a device for use in controlling body order is comprised of a substrate treated with an aqueous amphoteric metal hydroxide containing copper in an amount of between one gram and thirty grams of copper per square yard of substrate, the substrate being formed with a size and dimension that is structured for placement in proximity to a wearer's body where body odor is produced.

In some embodiments, the amount of copper in the substrate is between 8 grams and 12 grams per square yard of the substrate.

In certain other embodiments, the substrate is sized and formed for use as an insole for placement in a shoe.

In yet other embodiments, the substrate is further treated with a binder agent to bind the amphoteric metal hydroxide to the substrate.

In a third aspect of the disclosure, a system for producing substrate material for controlling body odor comprises a quantum of substrate material, a first aqueous solution containing an amphoteric metal compound, and a source of ammonia.

In some embodiments of the system, the quantum of substrate material is a keratin-based material.

In other embodiments, the system further comprises a solution containing a polymeric-based binder agent.

In a fourth aspect of the disclosure, a composition for treating a substrate to render the substrate effective for controlling body odor comprises an aqueous solution of an amphoteric metal compound having solubility in water <10 ppm by weight, and solubility in a 2% HCl solution >1000 ppm by weight, and a binder agent containing a polyvinyl acetate.

In some embodiments, the amphoteric metal compound contains copper.

In other embodiments, the aqueous solution of amphoteric metal compound contains, by weight, at least ½% of an amphoteric metal hydroxide, 1% ammonium chloride, and 1% carbonate.

In yet other embodiments, amphoteric compound contains a hydroxide selected from the group comprising cupric hydroxide, cupric carbonate hydroxide and hydrous basic copper aluminum phosphate (turquoise).

Although the various aspects of the disclosure can be employed in the reduction or elimination of odor arising from the activity of microorganisms in a moist environment on the body of an animal, both human and non-human, the various aspects of the disclosure are described herein with respect to use of the disclosure in the production of treated materials that are placed in proximity to human feet to reduce or eliminate the occurrence of foot odor, by way of example only. The aspects of the disclosure may be readily adapted to any number of other uses in the reduction or elimination of body odors arising on other parts of the body.

Other aspects, features and advantages will become apparent from the following detailed description when taken in conjunction with the accompanying drawing, which is a part of this disclosure and which illustrates, by way of example, principles of the inventions disclosed.

### DESCRIPTION OF THE FIGURE

The accompanying drawings facilitate an understanding of the various embodiments, in which:

FIG. 1 is a schematic representation of one embodiment of the disclosure illustrating a shoe insert made in accordance with the disclosure.

### DETAILED DESCRIPTION

The various aspects of the disclosure have as their objective the reduction or elimination of undesirable odor, such as that produced as a product of human sweat with the presence of microorganisms, said reduction being achieved by the use of a chemical compound containing materials from the class of amphoteric metal hydroxides (AMHs). The chemical compounds of the disclosure are used to treat a substrate, such as fabric, woven or non-woven materials, either natural or synthetic, which are to be positioned in close proximity to a part of the human body that may produce sweat and, thus, give rise to the production of odor.

The treated substrates of the disclosure are an improvement over known odor-controlling devices because they can be embodied in such a way that their effectiveness is not significantly diminished by profuse sweating or by multiple machine washings, or other exposure to water.

The long-lasting effectiveness arises because AMHs, such as Cu[OH]₂ and other copper-containing compounds, have very low solubility in water, in human sweat and in water containing detergent, such as is used in the washing of clothing. The presence of AMHs in a substrate that is worn in proximity to the human (or other animal) body significantly reduces biological activity of microorganisms, perhaps because acids produced by the microorganisms cause the metal ions in the AMHs to become soluble temporarily and to penetrate the microorganisms. Specifically, AMHs appear to reduce the gas released by microorganisms under conditions which would otherwise lead to growth and significant release of odor-causing gasses.

It has been demonstrated that a substrate treated with an AMH in accordance with the present disclosure, when subsequently infused with yeast in a growth medium, will reduce the resulting CO₂ emission (an indicator of biological activity) to less than 1% compared to the same fiber without AMH, and significant reduction of CO₂ emission is observed even after several machine washings of the AMH-treated substrate. Foot insoles incorporating the aspects of the disclosure are much more effective at reducing odor, compared to existing activated-carbon odor-absorbing insoles or anti-microbial-infused insoles, and do so for a longer period of time despite continued exposure to sweat, and even after machine washing. By comparison, as soon as activated-carbon insoles or anti-microbial-infused insoles become ineffective, after only a few weeks of use, due to being saturated by odors or being diluted by human sweat, such carbon-containing insoles cannot be restored by washing, and are, instead, discarded.

In general, one aspect of the disclosure comprises the incorporation of an AMH into a substrate by treating the substrate with the AMH in such a way that the AMH is not easily removed, for example, by abrasion or by washing in a near-neutral-pH aqueous solution. However, the treatment of the substrate with the AMH should be done in such a way that at least some of the AMH will become soluble if the treated substrate surface is placed in a sufficiently acidic solution (thus at least some of the AMH should be readily accessible to exterior chemical reactions).

Amphoteric metal hydroxides that are particularly useful in the aspects of the disclosure include those having divalent copper or divalent zinc, such as Cu(OH)₂ and Zn(OH)₂. Both have low water solubility, or are relatively insoluble in water (<10 ppm W/W solubility at 20° C.). The AMH compounds that are useful in the various aspects of the disclosure are relatively soluble in 2% HCl solution (>1000 ppm W/W solubility at 20° C.), however. As described more fully herein, other copper-containing compounds that are useful in the various aspects of the disclosure include copper carbonate hydroxide, or the mineral malachite (Cu₂[OH]₂CO₃), and the mineral turquoise (CuAl₆[PO₄]₄.[OH]₈.4[H₂O]).

In one aspect of the disclosure, an aqueous amphoteric metal hydroxide solution is mixed with a binder that facilitates the adherence of the AMH to the substrate. Such binders may include polyvinyl acetate (PVA) glue (including aliphatic-modified PVA glue and PVA-acrylate copolymer glue), latex rubber (including foamed latex), latex acrylic, nylon (if initially dissolved in an appropriate solvent, such as formic acid) and water-polymerized urethane glue (for example, Gorilla Glue). As described more fully below, in certain treatments with copper hydroxide, the binder can be keratin, for example, in the form of wool.

The copper compound+PVA glue or latex rubber mixture is used to treat a substrate that is intended for placement in proximity to a human body. In the case of reducing the proliferation of foot odor, the substrate may constitute the inner surface of a shoe (i.e., that surface which is positioned toward the sole of the foot) or may constitute an insole insert of a type that may be permanent or removable.

A particularly suitable mass of copper per area of treated substrate, in accordance with the disclosure, is approximately 1 gm to 30 gram (as copper) per square yard of treated substrate material. A preferred mass of copper in the treated substrate is between 8 gm and 12 gm per square yard. The preferred mass of copper in the treated substrate may be 10 gm per square yard. As used herein, “square yard” refers to the linear dimensions of the substrate material and, in the case of a fiber or foam material, does not refer to the (much larger) total surface area of the fibers or foam cells.

If the binder is PVA glue or latex rubber, the dry weight of the binder may preferably be about 20 grams/sq yard of substrate material.

In another aspect of the disclosure, substrate material is treated with an amphoteric metal hydroxide compound in admixture with a binder, using various treatment methods. In accordance with one method of manufacturing foot insoles, a polyester fiber is selected as the substrate to be treated. Polyester fiber has beneficial characteristics of having good mechanical properties and being a low cost material. A latex rubber binder is used to improve adhesion of the AMH to the substrate. Latex rubber has excellent durability when exposed to human sweat and multiple washings. The AMH will both adhere to latex rubber and diffuse into the binder for long-term durability of the odor-controlling characteristics of the substrate.

In this method, latex is diluted with an aqueous ammonia solution so that the latex rubber can be thinned to facilitate the coating of most of the polyester fibers. Although, ultimately, the latex rubber coverage of the surface area of the polyester fibers may not be achieved to 100 percent coverage, the coverage is sufficient to be effective. The addition of an amount of NaOH to the dilute latex-ammonia solution allows the latex rubber to accept the AMH coating better, even after the latex has dried.

A liquid latex solution, by weight, is produced as follows: 300 ml of water is mixed with 90 grams of aqua ammonia. (Aqua ammonia solution is 25% NH₃ by weight). Then, 170 grams of liquid latex rubber (such as KreemTex™ Liquid Rubber from “ArtMolds”, Summit, N.J., www.artmolds.com) is gently stirred into the water and aqua ammonia mixture, limiting the introduction of air into the mixture. The mixture is stirred until smooth. The resulting latex solution is referred to herein as “Solution A”.

A second solution, referred to herein as “Solution B”, is prepared by dissolving 30 grams of NaOH in 400 ml of water and then adding a surfactant (e.g., 2.5 grams of all® Free Clear Liquid Detergent, made by Sun Products Corporation of Wilton, Conn.) widely available in many retail stores).

Solutions A and B above are mixed together, by pouring Solution B into Solution A while stirring. The combination of Solution A and Solution B make a solution hereafter referred to as “Solution 1”, which can be kept for up to four weeks at room temperature, if sealed.

A sheet of polyester felt (white polyester felt, 1/16″ thick, 11 oz./square yard (available from “The Felt Company”, www.thefeltcompany.com, Madison Heights, Mich.) is soaked in Solution 1 at room temperature until all the fibers are visibly wetted. At room temperature, all fibers are wetted typically within 20 seconds. Before soaking the substrate material, or felt, in Solution 1, the sheet of felt may previously be cut to a desired shape of an insole or the treated sheet of felt may be cut to a desired shape after completion of the treatment. After all fibers are wetted, the wet sheet is removed from Solution 1 and is compressed, such as through rubber pinch rollers, to remove any excess of Solution 1 from the substrate. Typical diameter of the pinch rollers may be one inch and typical force may be 20 pounds of pressure per linear inch.

After being compressed, the resulting polyester-latex-treated substrate is dried fully at room temperature (e.g., between 68° F. and 70° F.). Notably, an atmosphere with high CO₂ concentrations should be avoided during drying to avoid converting the NaOH from the solution to the carbonate. Exposure to normal levels of CO₂ (<500 ppm) for 24 hours or less will not interfere with the process. Drying at room temperature on a screen requires typically six hours.

After drying, the treated substrate is soaked in a 20% by weight aqueous solution of CuCl₂.2H₂O, hereinafter referred to as Solution 2. Solution 2 reacts with some of the NaOH in the latex, forming Cu[OH]₂ and also forming some NaCl (which will be subsequently rinsed away). In addition, some unreacted CuCl₂.2H₂O diffuses into the latex. The substrate is soaked for at least one minute in Solution 2, at room temperature, with enough agitation to allow all fibers in the substrate to be exposed to non-depleted Solution 2. Agitation can be accomplished using at least 10 grams of Solution 2 per gram dry weight of latex-treated polyester sheeting, then soaking the sheet for at least a further twenty seconds after all fibers are visibly wetted. The substrate sheet is then removed from the bath, Solution 2 is stirred to remix the constituents, and then the sheet is re-soaked in the re-mixed Solution 2 for at least twenty more seconds.

After soaking, the sheet is compressed between rollers, as described before, to remove excess Solution 2. The sheet is then fully dried. After drying, the treated sheet is subsequently soaked in a 5% by weight NaOH aqueous solution, which also contains 0.25% surfactant (e.g., all® Free Clear Liquid Detergent, made by Sun Products Corporation of Wilton, Conn.), and at least 0.2% Cu[OH]₂, mostly as a precipitate. This solution of NaOH, surfactant, and Cu[OH]₂ will be referred to hereafter as Solution 3. The amount of Solution 3 should be at least 20 times the dry weight of the polyester-latex sheet (i.e., 20 grams of Solution 3 per gram of sheet dry weight). The substrate sheet is soaked in Solution 3 at room temperature, typically for at least two minutes, with moderate agitation. This agitation can be accomplished by soaking the sheet in Solution 3 until all fibers have been visibly coated, which occurs when the fibers change color from green to a cyan color. The sheet is then removed from the bath, drained for approximately five seconds, and then re-soaked for another five seconds. The steps of draining and re-soaking the substrate should be repeatedly conducted for at least one minute. The purpose of Solution 3 is to react with the quantity of copper chloride which had diffused into the latex rubber, by contributing OH (from the NaOH) to convert the diffused copper chloride to Cu[OH]₂. After the final soak, essentially all the copper contained within the latex will be Cu[OH]₂. However, Cu[OH]₂ is slightly soluble in NaOH solution, hence Solution 3 must contain a saturating concentration of Cu[OH]₂ to prevent unintended removal of some Cu[OH]₂ from the latex.

The substrate is then rinsed in water (with or without surfactant) to remove NaCl and any non-adhering Cu[OH]₂. The rinse requires typically two minutes and can be done by serially repeating a five second drain and five second soak in clean water for a total of two minutes. When fully rinsed, little or no cyan-colored precipitate will appear in a clean-water rinse of the sheet. One way to quantify a successful rinse is if ten square centimeters of substrate is squeezed with 100 newtons of force for ten repetitions in 100 ml of clean water, the visibility within the resulting rinse water should be greater than 50 cm. The sheet is then dried and is ready for use.

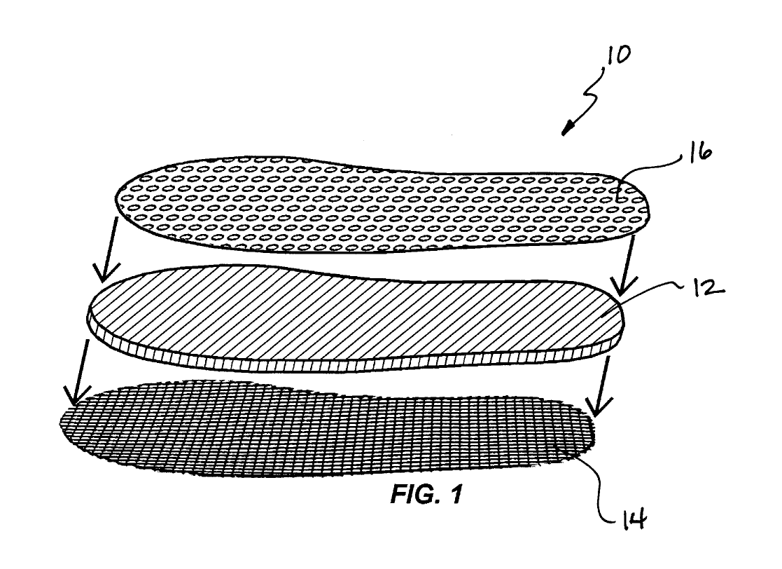

The substrate sheet that is made in accordance with the previously described method can be adapted for any number of uses for the reduction or elimination of body odor. As shown in FIG. 1, the treated sheet may be used as an insole insert 10 for placement in a shoe. In one embodiment, the treated substrate 12 may be adapted for use as the manufactured insole of the shoe in a permanent securement therewith. Consequently, the treated substrate would be incorporated into the manufacture of the shoe and become a permanent part of the shoe construction; although, in some embodiments, the insole may be removable and replaceable.

In a further embodiment, the treated substrate 12 may be incorporated into a removable insole insert 10. Depending upon the type of material that is used for preparation of the treated substrate, the resulting treated substrate may be of a lighter weight and stiffness, and may be subject to undesirable flexure within the shoe. Therefore, the treated substrate may be conjoined with a stabilizing element 14 that is cut in approximately the same shape or size as the treated substrate 12. The stabilizing element 14 is adhered to the treated substrate 12 to provide stiffness to the insole insert 10. The stabilizing element 14 may be glued onto, or melted on to (using a heat press), the underside of the treated substrate 12.

The stabilizing element 14 may be made of any suitable material that can provide the desired stiffness. For example, the stabilizing element 14 may be made from polypropylene mesh (e.g., product # XN1678 from “Industrial Netting”, Minneapolis, Minn., www.industrialnetting.com), with the flatter side of the mesh material facing the underside of the treated substrate.

Also, as shown in FIG. 1, a thin separator sheet 16 of polyester thermo-pressed non-woven fabric may be adhered to the top side of the treated substrate to provide a separation between the wearer's foot (with or without a stocking) and the treated substrate 12 of the insole insert 10. The separator sheet 16 provides reduction in friction between the wearer's foot and the substrate 12 of the insole insert 10, and reduces the sensation of dampness on the sole of the foot. The separator sheet 16 may be made of any suitable material, such as 0.010 inch thick, Smart-fab® material “Disposable Art & Decoration Fabric”, available from www.walmart.com.

To join the stabilizing element 14 to the treated substrate 12, 3M-brand “SUPER 77®” spray adhesive may be used to spray on a first side of the stabilizing element 14, which is immediately pressed onto the substrate 12. Attachment of the separator sheet 16 to the treated substrate 12 is achieved in a similar fashion, except that the adhesive is sprayed onto the top side of the substrate 12, and the separator sheet 16 is immediately pressed onto the sprayed top side surface of the substrate 12. A suitable spray adhesive is available in an aerosol spray can from multiple retail store chains, such as Office Depot. Assuming that all the adhesive is directed toward the intended target (stabilizing element 14 or treated substrate 12), a spray time of 12 seconds per square foot (per side) or equivalent substrate area is sufficient to assure adhesion. Alternatively, the treated substrate 12 may be bonded to the stabilizing element 14 by use of a heat press. Application of a hot surface to a polypropylene stabilizing element at a temperature of approximately 400° F. for four seconds at a pressure of 20 lbs. per square foot, pressing the stabilizing element onto the treated substrate, will join them permanently without need for adhesive material.

In further embodiments of the disclosure, various types of material may be selected for use as the substrate to be treated. For example, if the substrate is desirably a fiber insole, a large-denier (typically 15 D) non-woven polyester fiber is particularly suitable. Typical fiber weight may be 250 grams/square yard. If the substrate is desirably a foam insole, latex foam is particularly suitable, with a weight of 500-1000 grams/square yard. Notably, when using latex foam, some of the selected copper compounds may advantageously mix with the latex foam of the substrate making a separate binder solution unnecessary in producing the treated substrate.

If the substrate is desirably a keratin-based material, then the substrate is selected from materials such as wool or hair (such as alpaca hair), and the AMH compound is preferably copper hydroxide (Cu[OH]₂), which can be dissolved in an ammonia solution, resulting in an aqua ammonia solution of Schweizer's reagent, Cu[NH₃]₄[H₂O]₂][OH]₂. Because copper hydroxide is amphoteric, it does not dissolve in water, but does dissolve in an ammonia solution, temporarily forming a complex with ammonia, but once the solution has dried, the complex will revert back to copper hydroxide. Standard aqua ammonia (25%) saturates at only about 3% copper hydroxide W/W, and the concentrated ammonia solution is hazardous to breathe. However, the ammonia in the aqua ammonia+copper hydroxide solution can be mostly substituted with harmless ingredients. For example, a wool substrate can be soaked in an aqueous solution which is composed of only 3% ammonia, 4% W/W of ammonium chloride and 10% W/W of sodium carbonate will also dissolve 3% copper hydroxide, and after drying, the ammonium chloride and sodium carbonate can be rinsed away. A wool substrate thus treated will retain as much copper hydroxide as a substrate treated in solution of 3% copper hydroxide (saturated solution) in aqua ammonia (25% ammonia). Upon being soaked in either formula of 3% copper hydroxide solution, the surface of the wool immediately absorbs the copper hydroxide. Excess solution is squeezed out of the substrate material, and the substrate is allowed to dry. Once all the ammonia has evaporated, the substrate is rinsed with tap water to remove excess, non-absorbed copper hydroxide from the surface of the substrate. The copper hydroxide that has been absorbed will remain in the wool fibers. The preferred weight of wool, in this example, is approximately 500 grams/square yard, as non-woven fiber.

In another embodiment of the disclosure, a treated substrate may be made which contains copper carbonate hydroxide, Cu₂CO₃(OH)₂, as the effective element for reducing or eliminating odor. In this embodiment, a solution was prepared combining 70 grams (gm) of PVA-acrylate copolymer glue (approximately 50% solids, such as RayVace® 331, made by Specialty Polymers Products, Inc. of Woodburn, Oreg.) with 70 gm of water and 28.8 gm CuCl₂.2H₂O. The solution was mixed at room temperature until all constituents were well mixed. A second solution was prepared combining 200 gm of water and 23.2 gm Na₂CO₃.H₂O. The second solution was slowly poured into the first solution while stirring until the two solutions were combined (approximately 20 seconds) to produce a “malachite and glue” suspension. Notably, CO₂ was visibly liberated from the admixture of solutions. Stirring was continued until the bubbles were gone. Non-woven polyester fiber (for example, 15 Denier, ˜250 grams/square yard felt) was soaked in this solution of malachite and glue suspension with agitation until the fiber was saturated. The fiber substrate was then pressed by passing the substrate between pinch rollers to reduce the absorbed solution to approximately 400 grams/sq yard. The treated substrate was then allowed to dry at room temperature. After drying, no additional rinse was required. The only soluble “impurity” present is NaCl, which is harmless and does not stain the foot. An additional stabilizing element, or air-permeable structure, may be bonded to a surface of the treated substrate to make the insole stiffer, if desired. The malachite copper carbonate hydroxide) generated in this process is in the form of fine particles, which may settle. The malachite and glue suspension should be stirred before each use.

In a further embodiment of the disclosure, a wool felt substrate may be treated with copper chloride hydrate (CuCl₂.2H₂O), in absence of a binder, to provide a treated substrate containing copper hydroxide as the amphoteric metal hydroxide. In this embodiment, the source of copper is the chloride salt instead of the less readily available copper hydroxide. Further, when the CuCl₂.2H₂O is added to an ammonia solution, both copper hydroxide and ammonium chloride are produced. The presence of ammonium chloride reduces the concentration of ammonia required to dissolve the resulting copper hydroxide. Specifically, 42 grams of CuCl₂.2H₂O was mixed with 237 gm of water and 83 gm of aqua ammonia (25%), and 1.5 gm of liquid laundry detergent (e.g., all® Free Clear Liquid Detergent, made by Sun Products Corporation of Wilton, Conn.). The mixture was stirred and more aqua ammonia was added slowly until the solution was no longer cloudy. (Aqua ammonia may vary in strength, depending on storage conditions.) Hereinafter, the mixture will be called “Solution 4”. A sheet of needle-punched non-woven wool felt, having a weight of approximately 500 grams/sq yard, was soaked in the solution until saturated. The saturated sheet was then removed from the solution and squeezed to remove the excess liquid, until approximately 750 g of solution per sq yard of wool felt remained in the wool. The sheet was then air dried at room temperature. The dried sheet was then rinsed with tap water to remove dry copper hydroxide powder clinging to the surface until the rinse water was clear (approximately 2 liters of rinse water per square foot of substrate was required). The rinsed sheet was then dried again at room temperature. In Solution 4, the product of the reaction, copper hydroxide, is fully dissolved and no stirring of the solution is needed after an extended storage period. The total amount of copper absorbed into the wool with this process depends on the grade of wool used, but is generally between 3 gm and 10 gm (as copper) per square yard. No “external” binder is needed in this process because the wool fibers absorb and retain copper hydroxide, even when rinsed. However a binder agent, of the types previously referred to, for example, may be incorporated as a coating over the treated fiber, to be applied after the Solution 4 treatment, or as an admixture with Solution 4. Other fibers that have similar properties to wool are hair or keratin-based materials, silk and glycol-modified polyester (PETG).

In yet another embodiment, the CuCl2.2H2O is used with a latex rubber binder to prepare the insole. Specifically, a solution was prepared by mixing 36 grams of CuCl₂.2H₂O with 800 gm water, 150 gm of aqua ammonia (25%) and 2.4 gm of liquid laundry detergent (e.g., all® Free Clear Liquid Detergent, made by Sun Products Corporation of Wilton, Conn.). The admixture was stirred until fully mixed. The amount of aqua ammonia can vary by +1-10% and is far in excess of the minimum required to dissolve the copper hydroxide product of the reaction. The excess amount of aqua ammonia allows liquid latex rubber to disperse uniformly when added to the solution. To the copper containing solution, 80 gm of high-ammonia liquid latex rubber (e.g., containing approximately 70% solids, such as RD-407 mask making latex, available from The Monster Makers of Cleveland, Ohio), was then added. The admixture was stirred well for approximately one minute until visibly uniform or homogeneous. The shelf life of the solution, after latex is added, is only about one day. A polyester fiber substrate was soaked in the solution until saturated, and was then removed. The saturated substrate was then pressed to remove excess solution so that approximately 700 gm of solution per sq yard remained. The substrate was then air dried at room temperature. Other materials may be used as the substrate in this embodiment, including synthetic fiber or open-cell foam.

In still another embodiment, turquoise can be employed as the amphoteric metal hydroxide in a treated substrate. Specifically, a solution was prepared, in a fume hood, by mixing 3.40 gm of CuCl₂.2H₂O with 15.95 gm of AlCl₃ (6 moles aluminum per mole of copper). Avoiding splashing due to excess heat, the mixture was slowly stirred into 250 gm of water. Then 16.32 gm of NaOH (20 moles of NaOH per mole of copper) were added and the admixture was stirred until uniformly mixed so that the viscosity no longer decreased as a result of stirring. Notably, the admixture was initially very viscous, but became thinner with stirring. Then 9.28 gm of 85% H₃PO₄ (4 moles of phosphate per mole of copper) were added and the admixture was stirred until uniformly mixed. The resulting solution was then heated to a temperature of between 200° F. and 210° for at least thirty minutes, while stirring occasionally. The solution was then cooled and filtered to ⅓ times w/w concentration (i.e., liquid was removed so that approximately 99 grams of a thick paste remained of the original approximately 295 grams of liquid). The discarded liquid is water and some NH₄Cl. The thick paste was ready to be reconstituted with an equal weight of tap water, although the turquoise in the paste was in the form of flakes about 100 microns in diameter and 1 micron thick. These flakes were too large to mix well into the fiber that was used, so the paste was mechanically ground with a mortar and pestle, imparting about 500 joules of mechanical energy to the 99 grams of paste in order to reduce the average flake size sufficiently. To 99 gm of paste were added 99 gm of water and 22 gm of RayVace® 331 glue. Non-woven polyester fiber (for example, 15 Denier, ˜250 grams/sq yard felt) was soaked in the admixture solution until the fiber was saturated. The fiber substrate was then pressed by passing the substrate between pinch rollers to reduce the absorbed solution to approximately 800 grams of remaining solution per sq yard. The treated substrate was then allowed to dry at room temperature.

Turquoise is comparably effective relative to the other copper compounds described herein, if applied with the same number of copper atoms per area of substrate. Because turquoise contains a smaller percentage of copper compared to other compounds, more mass of turquoise is needed.

Fiber substrate samples prepared as described above (with both latex and PVA binders) were tested to determine the extent to which the three compounds, copper(ii) hydroxide (Cu[OH]₂) or copper carbonate hydroxide (Cu₂CO₃[OH]₂) or turquoise (CuAl₆[PO₄]₄[OH]₈.4[H₂O]), would inhibit the metabolic activity of baker's yeast in a growth medium. The growth medium was saturated onto each substrate sample, as well as onto control samples, which were identical, except that the controls contained no copper compound. Samples were tested after as many as five typical machine washes on “warm” cycle with laundry soap. After coating with yeast-infused growth medium, the samples were immersed in mineral oil to trap and measure evolved CO₂, a measure of metabolic activity. For an equal copper weight of 10 grams/sq yard, all three copper compounds performed comparatively equally. Notably, more total weight of turquoise/square yard was used because turquoise has a higher molar mass per mole of copper. Without any washing, all copper AMH-treated samples reduced the volume of CO₂ gas emission (per gram of growth medium) to approximately 1/100 compared to the controls. The controls, being untreated fiber saturated with growth medium, typically emitted 1500 cubic mm of CO₂ gas per gram of growth medium after 24 hours at room temperature immersed in mineral oil. The growth medium was composed of 0.2 gm of KCl, 0.2 gm of NaCl, 3.5 gm of sucrose, 2.5 mixed egg liquid, 12.5 gm of water and 0.4 gm of dry baker's yeast. For treated substrates that were machine washed once, as well as treated substrates that were machine washed five times, the relative reduction in CO₂ emission was approximately 1/50 compared to the controls. Thus, a single washing reduced the efficacy of the AMH-treated samples very slightly, although a further four washings did not measurably reduce the efficacy further.

In each of the foregoing embodiments, and in accordance with the disclosure, the actual mass of copper deposited in the treated substrate is between 1 gram and 30 grams per square yard of substrate material. Preferably, the mass of copper in the treated substrate is between 8 grams and 12 grams per square yard, and may more preferably be about 10 grams per square yard of substrate material.

The chemical solutions described herein that employ an external binder of PVA or PVA with copolymer glue or latex rubber may be used, interchangeably, to treat a substrate made of fiber or foam, or may be used to treat directly the inside surfaces of footwear, or to treat a surface that is intended to be placed in contact with or in close proximity to the human foot. Socks composed of any type of fiber can be coated by using the embodiment previously described which uses Solutions 1, 2 and 3.

Certain additives may be included in the formulas, including colorants, fragrance and bitterants (bittering agents) to prevent children or pets from accidental ingestion.

The manufactured articles made in accordance with the present disclosure are varied and may include pre-coated insoles that are inserted by the end user into footwear, a liquid solution that is painted into footwear by the end user, and footwear in which a manufacturer has either coated the inside surfaces of the shoe or has treated pre-fitted insoles in accordance with the disclosure.

In addition to shoe insoles, AMH-treated substrates may be used to reduce odor by being added to the inside surfaces of clothing, at various locations, such as under the arms. Other substrates that may be treated in accordance with the methods of the disclosure may include materials that the human foot comes in contact with on a continuous basis, such floor mats or area rugs, which may be subject to the development of odor. An appropriate coating may be applied directly to the inside surfaces of shoes, boots or socks.

Several other types of fiber or foam may be used as the substrate. Most other types of polymer fabric (e.g. polyolefins) and foam, other than latex rubber foam, (e.g., other foam such as polyurethane or ethylene vinyl acetate) may not bond well to AMHs. Consequently, the methods described hereinabove which employ solutions containing binder agents, such as latex rubber, or PVA glue, or PVA-acrylate copolymer glue, can be employed to modify these fabrics or foams to better accept AMH contact with the substrate. In addition to latex rubber, another substance that allows AMH bonding is latex acrylic, which is often used as paint.

It is noted that CuCl₂.2H₂O is soluble in acetone, and this solution can be added to non-ionic glues and paints, such as to urethane “Gorilla Glue” or to enamel paint, to produce a coating which can be converted to Cu[OH]₂ by subsequent exposure to an alkaline chemical, which substitutes OH for the Cl. Exposure to an alkaline chemical should usually be performed soon after the glue or paint (containing some acetone and CuCl₂.2H₂O) is used to treat a substrate, before the substrate dries, to maximize the amount of substitution. Exposure can be effected by dipping in a solution, of the type described hereinabove as Solution 3, or by exposing the substrate to ammonia vapor in a closed container. In this process, 5% W/W of CuCl₂.2H₂O is mixed into a solution of 10% water W/W in acetone. The resulting solution is added to air-curing urethane glue, such as “Gorilla Glue”. The W/W mix ratio is one part copper chloride solution to 2 parts urethane glue. The glue will harden rapidly, and mixing should be rapid, because the admixture should be used to soak substrate material within one minute. After soaking to saturation, excess liquid admixture is immediately removed, leaving approximately 200 grams of liquid per square yard. Within one further minute after excess liquid removal, the substrate is soaked in Solution 3, as described hereinabove, for at least one minute and then rinsed and dried.

Certain fibers can be treated directly, using Solution 4 described herein, with AMH, which will adhere well without need for a binder. These fibers include the keratin proteins (e.g., wool, silk, hair) and cellulosics (e.g. cotton, rayon, linen). The amphoteric metal hydroxide, Zn[OH]₂, like Cu[OH]₂, is excellent for odor reduction. In order to treat substrates with Zn[OH]₂, substitute 33.6 gm of ZnCl₂ for the 42·gm of CuCl₂.2H₂O in Solution 4, as described above. A substrate is soaked in ZnCl₂-substituted Solution 4 and then treated with 5% NaOH solution.

Fibers that can be directly treated with AMH materials without using binders can also employ Solution 4 for the treating process as described herein. These fibers only need to be soaked a minimum of five seconds in Solution 4 until fully wetted, and are then compressed to remove excess liquid and then partially or completely dried. The surfactant (in the concentration described hereinabove) in the solution will speed the wetting. As soon as the ammonia component of Solution 4 has evaporated from the substrate, the substrate can be rinsed with tap water and dried for use. Any excess Cu[OH]₂ not adhering to the surface will be removed during this rinse process, but the Cu[OH]₂ that was absorbed into the fiber is not rinsed off.

Cellulosic fibers may partially melt in Schweizer's reagent, which has been used specifically to dissolve cellulose for the production of rayon. A better application of Cu[OH]₂ on cellulosic fibers results when using Solution 4. Treated cellulosic fibers lose more Cu[OH]₂ during washing and tend to fray, compared to polyester that has been coated using with AMH and a binder agent, as previously described. For improved durability, if a cotton substrate is to be used, it should not be a non-woven felt, but rather, it should be more-durable woven cotton, such as terry cloth, and for additional durability, may be coated with a binder agent as described hereinabove.

Wool felt, especially SAE pressed felt (e.g. F-1), has excellent breathing, firmness and AMH adhesion properties. However, F-1 wool felt is very expensive, costing typically more than ten times the price of equivalent polyester felt. Lower, less expensive grades of wool will fray, shed and lose strength when washed, but they retain Cu[OH]₂ well after being coated. The lower grades of wool can be partially stabilized by treating with a binder agent after treating with Solution 4

Nylon fiber can retain an AMH treatment, although like wool, nylon is expensive. Nylon will absorb CuCl₂.2H₂O when soaked in a concentrated aqueous solution that is heated. Typically, a 40% by weight solution of CuCl₂.2H₂O (with a trace of surfactant, at similar concentration as in Solution 1) is heated to boiling, into which nylon felt is immersed for ten seconds. Then the felt is compressed and soaked in Solution 3, using agitation similar to the embodiment description above. After drying, the coated nylon felt will appear more green (as opposed to cyan) than is typical of Cu[OH]₂, but the effectiveness, even after washing, is retained. The coated nylon felt will revert to a typical cyan color if subsequently dipped in aqua ammonia solution. Nylon can also be used, in a way similar to latex rubber, to bind AMH to other fibers. An aqueous solution of (by weight) 15% HCl, 15% glacial acetic acid, 15% Cu[NO₃]₂.2½H₂O (or equivalent molality of any cupric salt) and 2.5% of 6-6 nylon can be used to dip polyester fiber at room temperature. The fiber is then wrung, dried, and soaked in Solution 3.

Solution 3 can, for most of the processes mentioned above, be replaced by exposure to ammonia vapor to contribute the OH groups to produce Cu[OH]₂ or Zn[OH]₂. This can be accomplished by hanging the substrate in air above a bath of aqua ammonia in a sealed container at room temperature for up to five minutes. After removal from the sealed ammonia vapor container, the substrate can be rinsed with tap water, but only after the ammonia has evaporated from the substrate.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, inventions have been described in connection with what are presently considered to be the most practical and preferred embodiments, it is to be understood that the inventions are not to be limited to the disclosed embodiments, but on the contrary, are intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. Method for treating a substrate to control body odor, comprising:
providing a quantum of substrate material to be treated;
providing an aqueous solution of an amphoteric metal hydroxide;
providing an amount of ammonia for reaction with said amphoteric metal hydroxide;
contacting said quantum of substrate material with said aqueous solution of an amphoteric metal hydroxide for a time sufficient to adhere the amphoteric metal compound to the substrate material;
drying the substrate material after contacting with the amphoteric metal hydroxide and ammonia; and
shaping the substrate material to a size and dimension that is structured for placement in proximity to a wearer's body where body odor is produced.

2. The method according to claim 1, further comprising the addition of a surfactant in admixture with said aqueous solution of an amphoteric metal hydroxide.

3. The method according to claim 1, wherein said ammonia is provided in the form of Schweizer's reagent solution.

4. The method according to claim 1, wherein said amphoteric metal hydroxide is produced by the reaction of a metal salt with ammonia vapor while an aqueous solution of said metal salt is in contact with said substrate material.

5. The method according to claim 1, further comprising providing a polymer-based binder agent and contacting said substrate with said binder agent.

6. The method according to claim 5, wherein said binder agent is contacted with said substrate before contacting said substrate with said aqueous amphoteric metal hydroxide.

7. The method according to claim 6, further comprising contacting said substrate with a solution of sodium hydroxide, surfactant and additional amphoteric metal hydroxide after contacting said substrate with said aqueous amphoteric metal hydroxide.

8. The method according to claim 5, wherein said binder agent comprises a liquid latex rubber.

9. The method according to claim 5, wherein said aqueous amphoteric metal hydroxide is produced from reaction of a water-soluble copper salt being admixed with a metal carbonate in aqueous solution, and said binder agent is a polyvinyl acetate emulsion glue, and further comprising the admixture of said aqueous amphoteric metal hydroxide and binder agent to water and Na₂CO₃ before contacting with said substrate.

10. The method according to claim 1, wherein said aqueous amphoteric metal hydroxide contains Cu(OH)₂ and Al(OH)₃, and further wherein said aqueous amphoteric metal hydroxide is mixed with H₃PO₄ and is filtered, the filtrate then being admixed with a binder agent before contact with said substrate.

11. The method according to claim 1, wherein the amphoteric metal hydroxide contains cupric hydroxide, copper carbonate hydroxide or hydrous basic copper aluminum phosphate (turquoise), or mixtures thereof.

12. The method according to claim 1, wherein the shaping of said substrate is performed before contacting said substrate with said aqueous amphoteric metal hydroxide.

13. A device for use in the control of body odor, comprising a substrate treated with an aqueous amphoteric metal hydroxide containing copper in an amount of between one gram and thirty grams of copper per square yard of substrate, the substrate being formed with a size and dimension that is structured for placement in proximity to a wearer's body where body odor is produced.

14. The device according to claim 13, wherein the amount of copper in the substrate is between 8 grams and 12 grams per square yard of the substrate.

15. The device according to claim 13, wherein the substrate is sized and formed for use as an insole for placement in a shoe.

16. The device according to claim 134, wherein said substrate is further treated with a binder agent to bind the amphoteric metal hydroxide to the substrate.

17. A system for producing substrate material for controlling body odor, the system comprising:
a quantum of substrate material;
a first aqueous solution containing an amphoteric metal compound; and
a source ammonia.

18. The system according to claim 17, wherein said quantum of substrate material is a keratin-based material.

19. The system according to claim 17, further comprising a solution containing a polymer-based binder agent.

20. A composition for treating a substrate to render the substrate effective for controlling body odor, the composition comprising:
an aqueous solution of an amphoteric metal compound having solubility in water <10 ppm by weight, and solubility in a 2% HCl solution >1000 ppm by weight; and
a binder agent containing a polyvinyl acetate.

21. The composition according to claim 20, wherein said amphoteric metal compound contains copper.

22. The composition according to claim 21, wherein said aqueous solution of amphoteric metal compound contains, by weight, at least ½% of an amphoteric metal hydroxide, 1% ammonium chloride, and 1% carbonate.

23. The composition according to claim 20, wherein said amphoteric compound contains a hydroxide selected from the group comprising cupric hydroxide, cupric carbonate hydroxide and hydrous basic copper aluminum phosphate (turquoise).
